(19) United States
(12) Patent Application Publication
(10) Pub. No.: US 2008/0083071 A1
(43) Pub. Date: Apr. 10, 2008

(54) CALCIUM HYPOCHLORITE FOR USE IN A LAUNDRY WASHING PROCESS

(76) Inventors: Mario Elmen Tremblay, West Chester, OH (US); Peter Robert Foley, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/973,483

(22) Filed: Oct. 9, 2007

Related U.S. Application Data
(60) Provisional application No. 60/850,697, filed on Oct. 9, 2006.

(51) Int. Cl. D06L 3/06; C11D 3/395

(52) U.S. Cl. 8/109; 510/302

(57) ABSTRACT

Calcium hypochlorite for use in a laundry washing process. The calcium hypochlorite may be provided in a solid form such as a tablet, granule, and/or powder. The calcium hypochlorite of the present invention may also utilize a sequestering agent. Additionally, other adjunct materials may be included. The present invention also relates to a process for using calcium hypochlorite in a laundry washing process.

### CROSS REFERENCE TO RELATED APPLICATIONS

This application claims the benefit of U.S. Provisional Application Ser. No. 60/850,697 filed on Oct. 9, 2006.

### FIELD OF THE INVENTION

The present invention relates to utilizing calcium hypochlorite in a laundry washing process.

### BACKGROUND OF THE INVENTION

In many instances it is desirable to utilize oxidizing agents such as chlorine-based bleach in the laundry washing process in order to enhance fabric cleaning. There are several different ways to introduce free chlorine into the laundry washing process. The most common way is via the addition of sodium hypochlorite. However, there are several drawbacks associated with using this form of free chlorine in a laundry washing process. For instance, as sodium hypochlorite is limited to a liquid form it tends not to be compatible with a delayed and/or a time release of the chlorine into the wash. Furthermore, this form tends to be incompatible with other common laundry additive materials such as enzymes, polymers, surfactants, color additives such as dyes, brighteners, and fragrance additives as the chlorine will interact with these materials so as to reduce their effectiveness. Yet further, sodium hypochlorite tends to stain and/or remove color if spilled or splashed onto the fabric. Even further, this form of free chlorine at typical addition levels can result in fabric damage over time with repeated usage.

Another way to introduce free chlorine into the laundry washing process is via the addition of lithium hypochlorite. However, this form of hypochlorite tends to be more costly and not as readily available as calcium hypochlorite. Other forms of free chlorine commonly used in industry include sodium dichloroisocyanurate or trichloroisocyanuric acid. However, both of these sources of chlorine provide less whitening of the fabric and hence are generally not recommended for use in a laundry washing process.

Hence, there is a need for an improved means of introducing free chlorine into the laundry washing process which overcomes the drawbacks associated with the use of sodium hypochlorite, lithium hypochlorite, dichlorisocyanurate acid, and trichloroisocyanuric acid. Furthermore, there is a need to find a way to utilize calcium hypochlorite in a laundry washing process which overcomes the drawbacks associated with introducing calcium ions into the laundry wash liquor. The present invention overcomes these drawbacks. The calcium hypochlorite of the present invention is provided in a solid form such as a tablet, powder, granule, or a combination thereof. As the calcium hypochlorite is provided in a solid form it overcomes the compatibility concerns associated with liquid sodium hypochlorite. For instance, the calcium hypochlorite of the present invention can be added to the laundry washing process on a time delay/time release basis such that the chlorine addition to the wash can be timed so as to maximize its efficacy while not inhibiting the efficacy of other laundry ingredients added to the wash. Furthermore, as the calcium hypochlorite is provided as a solid, other materials which are incompatible with sodium hypochlorite can be formulated and used in conjunction with the calcium hypochlorite so as to provide additional fabric care benefits. Yet further, as the calcium hypochlorite is provided in a solid form, it overcomes the drawbacks related to staining and color removal associated with spilling and/or splashing liquid sodium hypochlorite on to a fabric. Additionally, parity levels of cleaning performance can be achieved utilizing the calcium hypochlorite of the present invention at lower chlorine levels than the chlorine levels associated with the use of sodium hypochlorite. Calcium hypochlorite also overcome the drawbacks associated with utilizing lithium hypochlorite in a laundry washing process as calcium hypochlorite tends to be readily available and more economical to use than lithium hypochlorite. In addition, calcium hypochlorite overcomes the yellowing drawbacks associated with both dischlorisocyanurate acid, and trichloroisocyanuric acid.

Furthermore, it is surprising to find that the calcium hypochlorite of the present invention can be utilized in a laundry washing process without the deleterious effects one would expect to see associated with introducing calcium hardness ions into the wash liquor. These deleterious effects include reduced effectiveness of laundry detergent ingredients such as surfactant. The present invention overcomes these deleterious effects as the invention includes a sequestering agent in addition to calcium hypochlorite. By formulating calcium hypochlorite in conjunction with a sequestering agent, the calcium hypochlorite can perform more effectively. Additionally, the calcium hypochlorite and sequestering agent of the present invention work synergistically with other laundry washing ingredients, such as surfactants, etc. to enhance the overall cleaning performance of the laundry washing ingredients.

### SUMMARY OF THE INVENTION

The present invention relates to utilizing calcium hypochlorite in a laundry washing application. The calcium hypochlorite may be utilized in conjunction with a sequestering agent.

### DETAILED DESCRIPTION OF THE INVENTION

Reference will now be made in detail to various embodiments of the present invention, examples of which are illustrated in the accompanying drawings wherein like numerals indicate the same elements throughout the views. All percentages, ratios and proportions herein are on a weight basis unless otherwise indicated.

Except as otherwise noted, all amounts including quantities, percentages, portions, and proportions, are understood to be modified by the word “about”, and amounts are not intended to indicate significant digits.

Except as otherwise noted, the articles “a”, “an”, and “the” mean “one or more”.

As used herein, “comprising” means that other steps and other ingredients which do not affect the end result can be added. This term encompasses the terms “consisting of” and “consisting essentially of”. The compositions and methods/processes of the present invention can comprise, consist of, and consist essentially of the essential elements and limitations of the invention described herein, as well as any of the additional or optional ingredients, components, steps, or limitations described herein.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

The present invention relates to utilizing calcium hypochlorite and a calcium sequestering agent which are formulated together as a composition in a solid form as an additive in a laundry washing process. The solid form composition which may in one non-limiting embodiment be comprised of a tablet may include other materials as well if desired. While not wishing to be limited by theory, it is believed that the introduction of some additional calcium (other than what is already present in the water added to the washing machine) into the laundry washing process via the addition of the solid form of the present invention may assist in enhancing the removal of calcium sensitive stains such as greasy stains when used in conjunction with surfactant (a common laundry wash ingredient). While not wishing to be limited by theory, it is believed that the calcium may enhance removal of greasy stains by allowing for improved packing of the micelle structure of the laundry detergent surfactant system. Yet further, while not wishing to be limited by theory, in one non-limiting embodiment it is believed that by formulating the calcium hypochlorite and calcium sequestering agent of the present invention together in a solid form, this form can be designed if desired so as to provide for the release of the calcium sequestering agent during the early stage of the laundry wash cycle prior to the release of the calcium included in the calcium hypochlorite. It is thought that by releasing the calcium sequestering agent prior to the calcium, laundry detergent performance issues resulting from incompatibilities of the calcium ions with other laundry wash ingredients such as surfactant, enzymes, polymers, and the like can be reduced. Generally speaking, it is desirable to have from about 10 ppm to about 300 ppm of free chlorine released in the laundry wash liquor, or from about 50 ppm to about 200 ppm of free chlorine released in the laundry wash liquor, or from about 75 ppm to about 150 ppm released in the laundry wash liquor.

In yet another aspect of the present invention, it is believed that the design of the solid form of the calcium hypochlorite allows for a delayed time release of the hypochlorite into the laundry wash process. While not wishing to be bound by theory, it is thought that this delayed time release provides greater synergy between the free chlorine species and other laundry ingredients as the delayed release of the free chorine provides an opportunity for the other laundry ingredients which may not be compatible and/or can be deactivated by chlorine (non-limiting examples of which include enzymes, surfactants, and the like) to act in the wash liquor before the chlorine is released into the wash liquor. For instance, in one non-limiting example, the solid form of the present invention containing the calcium hypochlorite can be designed so as to have the greatest portion of the hypochlorite released from the solid form after the addition of other laundry ingredients into the wash liquor such as the surfactant and enzymes.

The solid form of the present invention may be provided in any shape including but not limited to circular, oval, cylindrical, spherical/round such as a ball or pearl shape, square, rectangular, triangular shaped, or combinations thereof. The solid form of the present invention may comprise from about 1% to about 55% by weight of calcium hypochlorite and from about 1% to about 55% by weight of a calcium sequestering agent. Calcium hypochlorite suitable for use with the present invention is available from PPG industries of Pittsburgh, Pennsylvania and from Arch Chemicals of Charleston, Tenn. Preferred calcium sequestering agents are citrate salts such as sodium citrate; citric acid; or a combination thereof. One suitable sodium citrate based sequestering agent is sodium citrate dihydrate. Other suitable calcium sequestering agents include but are not limited to carbonate-based sequestering agents such as sodium carbonate; silicate-based sequestering agents such as aluminosilicate, a non-limiting example of which is zeolite; sodium silicate; phosphate-based sequestering agents such as hydroxyl-ethylene 1,1 diphosphonate (“HEDP”); diethylenetriamine pentaacetic acid (“DTPA”); ethylenediaminetetraacidic acid (“EDTA”); sodium tripolyphosphate (“STPP”); and combinations thereof.

If desired, the solid form of the present invention may also include from about 1% to about 30% by weight of a disintegrating agent. While not wishing to be limited by theory, it is believed that when used, the disintegrating agent will assist with the dissolution of the tablet after it is added to the wash liquor. Suitable disintegrating agents include but are not limited to cellulose based materials including but not limited to carboxymethyl cellulose (“CMC”); chitosan; effervescent aids including but not limited to combinations of anhydrous acid with carbonate and/or bicarbonate salts; clays such as bentonite clay; synthetic layered silicate/clay; and combinations thereof. One suitable synthetic layered/clay is the CELITE series such as calcined diatomaceous earth CAS # 68855-54-9 available from Celite Corporation of Lompoc, Calif. One suitable synthetic layered silicate/clay is the LAPONITE series such as LAPONITE RD available from Southern Clay Company (a division of Rockwood Specialties) of Princeton, N.J.

In addition to detersive ingredients (including but not limited to surfactants, enzymes, builders, pH modifiers, etc.) which may be added to the wash liquor separately from the solid form of the present invention, it may also be desirable to include one or more of these detersive ingredients in the composition of the solid form of the present invention. For instance, in one non-limiting embodiment, one or more surfactants may optionally be included in the solid form of the present invention. When included, the surfactant will typically comprise from about 1% by weight to about 40% by weight of the composition of the solid form. Suitable surfactants for this purpose include but are not limited to anionic, nonionic, zwitterionic, ampholytic, cationic, or compatible mixtures thereof. Detergent surfactants useful herein are described in U.S. Pat. No. 3,664,961, Norris, issued May 23, 1972, U.S. Pat. No. 3,919,678, Laughlin et al., issued Dec. 30, 1975, U.S. Pat. No. 4,222,905, Cockrell, issued Sep. 16, 1980, and in U.S. Pat. No. 4,239,659, Murphy, issued Dec. 16, 1980.

Useful anionic surfactants can themselves be of several different types. For example, water-soluble salts of the higher fatty acids, i.e., “soaps”, are useful anionic surfactants in the compositions herein. This includes alkali metal soaps such as the sodium, potassium, ammonium, and alkylolammonium salts of higher fatty acids containing from about 8 to about 24 carbon atoms, and preferably from about 12 to about 18 carbon atoms. Soaps can be made by direct saponification of fats and oils or by the neutralization of free fatty acids. Particularly useful are the sodium and potassium salts of the mixtures of fatty acids derived from coconut oil and tallow, i.e., sodium or potassium tallow and coconut soap.

Additional non-soap anionic surfactants which are suitable for use herein include the water-soluble salts, preferably the alkali metal, and ammonium salts, of organic sulfuric reaction products having in their molecular structure an alkyl group containing from about 10 to about 20 carbon atoms and a sulfonic acid or sulfuric acid ester group. (Included in the term “alkyl” is the alkyl portion of acyl groups.) Examples of this group of synthetic surfactants are a) the sodium, potassium and ammonium alkyl sulfates, especially those obtained by sulfating the higher alcohols (C₈-C₁₈ carbon atoms) such as those produced by reducing the glycerides of tallow or coconut oil; b) the sodium, potassium and ammonium alkyl polyethoxylate sulfates, particularly those in which the alkyl group contains from 10 to 22, preferably from 12 to 18 carbon atoms, and wherein the polyethoxylate chain contains from 1 to 15, preferably 1 to 6 ethoxylate moieties; and c) the sodium and potassium alkylbenzene sulfonates in which the alkyl group contains from about 9 to about 15 carbon atoms, in straight chain or branched chain configuration, e.g., those of the type described in U.S. Pat. Nos. 2,220,099 and 2,477,383. Also useful are linear straight chain alkylbenzene sulfonates in which the average number of carbon atoms in the alkyl group is from about 11 to 13, abbreviated as C₁₁₋₁₃ LAS.

Preferred nonionic surfactants are those of the formula R¹(OC₂H₄)ₙOH, wherein R¹ is a C₁₀-C₁₆ alkyl group or a C₈-C₁₂ alkyl phenyl group, and n is from 3 to about 80. Particularly preferred are condensation products of C₁₂-C₁₅ alcohols with from about 5 to about 20 moles of ethylene oxide per mole of alcohol, e.g., C₁₂-C₁₃ alcohol condensed with about 6.5 moles of ethylene oxide per mole of alcohol.

Additional suitable nonionic surfactants include polyhydroxy fatty acid amides of the formula:

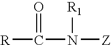

wherein R is a C₉₋₁₇ alkyl or alkenyl, R₁ is a methyl group and Z is glycidyl derived from a reduced sugar or alkoxylated derivative thereof. Examples are N-methyl N-1-deoxyglucityl cocoamide and N-methyl N-1-deoxyglucityl oleamide. Processes for making polyhydroxy fatty acid amides are known and can be found in Wilson, U.S. Pat. No. 2,965,576 and Schwartz, U.S. Pat. No. 2,703,798, the disclosures of which are incorporated herein by reference.

If desired, the solid form of the present invention may also optionally include from about 0.005% to about 5% by weight of a brightener and from about 0.01% to about 10% by weight of a stain removing agent. One non-limiting example of a suitable brightener is BRIGHTENER 49 available from Ciba Specialty Chemicals of Basel, Switzerland. One non-limiting example of a suitable stain removing agent is ammonium fluoride available from General Chemical Corporation of Parsippany, N.J.

If desired, the solid form of the present invention may also optionally include from about 0.001% to about 1% of a chlorine scavenger. One suitable non-limiting example of a chlorine scavenger is sodium sulfite.

It may optionally be desirable to apply a coating to all or some portion of the calcium hypochlorite particles. While not wishing to be limited by theory, it is believed that the coating can help provide a time release/delayed release of the calcium hypochlorite particles into the wash liquor. Furthermore, it is believed that when used, the coating allows for solid forms which may incorporate ingredients which are normally incompatible with one another (e.g.; enzymes and chlorine). The solid form may be comprised of from about 0.5% to about 50% by weight of a coating or from about 1% to about 25% by weight of a coating. The coating may be comprised of one or more layers. Furthermore, when used, each layer of coating may be comprised ofone or more materials. Non-limiting examples of suitable coating materials include but are not limited to mono, divalent, and trivalent ions and their counter ions. For example, lithium, sodium, potassium, beryllium, magnesium, calcium, boron, and aluminum either singly or in combinations may be coupled to carbonate, sulfate, oxalate, silicate, chloride, oxide, citrate, or stearate. Other suitable coating materials include but are not limited to LAPONITE, alumina, and titanium dioxide. Preferred coatings include sodium sulfate, sodium chloride, sodium carbonate, sodium silicate, magnesium sulfate, and combinations thereof. These coating materials may be applied to the calcium hypochlorite in a homogeneous manner and/or they may be applied so as to one or more layers of inorganic salt surrounding the calcium hypochlorite particle. If desired, the coating material could also be blended with other materials including but not limited to surfactant.

It may also be desirable to include optional processing aids including but not limited to a binding agent. The solid form may include from about 0.1% to about 50% by weight or from about 0.5% to about 25% by weight or from about 1% to about 5% by weight of a binding agent. Non-limiting examples of suitable binding agents include polyacrylates such as sodium polyacrylate; crystalline inorganic salts such as sodium chloride; or cellulose-based materials such as CMC; or combinations thereof. It may also be desirable to include a lubricating agent. The solid form may include from about 0.1% to about 5% by weight of a lubricating agent. Suitable lubricating agents include but are not limited to boric acid, sodium borate, magnesium stearate, and stearic acid.

It may also be desirable for the solid form to optionally include from about 1% to about 30% of a pH modifier. Suitable pH modifiers include but are not limited to sodium silicate, sodium carbonate, citric acid, potassium hydroxide, or a combination thereof.

It may also be desirable for the solid form to optionally include filler materials. When a filler material is used the solid form may include from about 0.1% to about 75% by weight of filler material. Suitable filler materials include but are not limited to sodium sulfate, sodium chloride, sodium carbonate, sodium silicate, and combinations thereof.

The delayed release of calcium hypochlorite into the wash liquor from the solid form may be accomplished via several non-limiting approaches or combinations thereof. Three suitable non-limiting approaches include: 1) providing a solid form which is a tablet wherein the tablet comprises an inner core and an outer core wherein the inner core comprises the calcium hypochlorite; 2) providing a solid form wherein all or some portion of the calcium hypochlorite particles are coated; and 3) providing a solid form comprised of a homogenously blended tablet wherein during processing of the tablet, pressure is applied so as to create a hard pressed tablet thereby slowing down the dissolution of the tablet and therefore slowing down the release of calcium hypochlorite into the wash liquor. Embodiments of each approach are disclosed below.

### 1. Tablet Comprising an Inner Core and an Outer Core

The solid form may comprise a tablet having an inner core and an outer core. The inner core may have a diameter of from about 0.1 cm to about 3 cm. The diameter of the entire tablet may be from about 0.2 cm to about 9 cm. Referring to Examples 1-4 in Table I, the inner core and outer core ingredients are each premixed into two sets of blended powders. The inner core blended powder is first pressed into a tablet. For this purpose a common tablet shape referred to as a plain flat face shape may be used. The diameter of the inner core mold may be about 0.5 inches (1.27 cm). The inner core is pressed using about 5 tons (4.5 metric tons) of pressure. One non-limiting example of a suitable press for this purpose is a Stokes press. Half of the material comprising the outer core blended powder is then placed in a larger compound cup molded shape mold that is 1.5 inches (3.8 cm) in diameter. The pressed inner core of the tablet is centered in the mold by hand at equal distance from all edges. The remainder of the outer core blended powder is then added on top of the pressed inner core. The tablet is then pressed at a pressure of approximately 15 tons (13.6 metric tons). Upon addition to the laundry wash liquor, it is desirable that the outer core of the tablet dissolve within from about two minutes to about seven minutes after contact with the aqueous wash liquor.

TABLE I
Example Compositions for Tablet Comprising an Inner Core and an Outer Core

| | | | |
|---|---|---|---|
| | Wt. % | | |
| | Per | | + |
| Grams | Tablet | Supplier | Location |

EXAMPLE #1

| | | | | |
|---|---|---|---|---|
| Inner Core Ingredients | | | | |
| Calcium Hypochlorite | 10.0 | 20.4 | PPG Industries | Pittsburgh, PA |
| LAPONITE RD | 3.0 | 6.1 | Southern Clay Products | Princeton, NJ |
| CELITE | 1.0 | 2.0 | Celite Corp. | Lompoc, CA. |
| Outer Core Ingredients | | | | |
| Sodium Citrate dihydrate | 9.0 | 18.4 | Tate & Lyle | Decatur, Il |
| Sodium Borate | 8.0 | 16.3 | North American Chem. | Shawnee Mission, KS |
| Sodium Sulfate | 16.0 | 32.7 | EMD Chemicals | Gibbstown, NJ |
| LAPONITE RD | 2.0 | 4.1 | Southern Clay Products | Princeton, NJ |

EXAMPLE #2

| | | | | |
|---|---|---|---|---|
| Inner Core Ingredients | | | | |
| Calcium Hypochlorite | 10.0 | 25.0 | PPG | Pittsburgh, PA |
| LAPONITE RD | 5.0 | 12.5 | Southern Clay Products | Princeton, NJ |
| Outer Core Ingredients | | | | |
| Sodium Citrate dihydrate | 9.0 | 22.5 | Tate & Lyle | Decatur, Il |
| Surfactant blend (Mid-Chain | 4.0 | 10.0 | P&G | Cincinnati, OH |
| Branched Alkyl Sulfate and | | | | |
| Alkyl Sulfate) | | | | |
| Sodium Sulfate | 11.35 | 28.3 | EMD Chemicals | Gibbstown, NJ |
| BRIGHTENER 49 | 0.15 | 0.4 | Ciba | Basel Switzerland |
| DTPA Agglomerate | 0.5 | 1.3 | P&G | Cincinnati, OH |

EXAMPLE #3

| | | | | |
|---|---|---|---|---|
| Inner Core Ingredients | | | | |
| Calcium Hypochlorite | 10.0 | 25.0 | PPG | Pittsburgh, PA |
| LAPONITE RD | 5.0 | 12.5 | Southern Clay Products | Princeton, NJ |
| Outer Core Ingredients | | | | |
| Sodium Citrate dihydrate | 12.0 | 30.0 | Tate & Lyle | Decatur, Il |
| Surfactant blend (Mid-Chain | 6.0 | 15.0 | P&G | Cincinnati, OH |
| Branched Alkyl Sulfate and | | | | |
| Alkyl Sulfate) | | | | |
| Sodium Sulfate | 4.32 | 10.8 | EMD Chemicals | Gibbstown, NJ |
| BRIGHTENER 49 | 0.15 | 0.4 | Ciba | Basel Switzerland |
| Sodium polyacrylate | 2.0 | 5.0 | Rohm & Haas | Springhouse, PA |
| Ammonium Fluoride | 0.5 | 1.3 | General Chemical Corp | Parsippany, NJ |

EXAMPLE #4

| | | | | |
|---|---|---|---|---|
| Inner Core Ingredients | | | | |
| Calcium Hypochlorite | 11 | 37.9 | PPG | Pittsburgh, PA |
| LAPONITE RD | 2.0 | 6.9 | Southern Clay Products | Princeton, NJ |
| Outer Core Ingredients | | | | |
| Sodium Citrate dihydrate | 11.0 | 37.9 | Tate & Lyle | Decatur, Il |
| Sodium Chloride | 5 | 17.2 | EMD Chemicals | Gibbstown, NJ |

### 2. Tablet Comprising Coated Calcium Hypochlorite Particles

The solid form may comprise a tablet which includes coated calcium hypochlorite particles such as shown in Examples 5-8 below. The calcium hypochlorite particles may be coated with an ingredient that is somewhat water soluble. One or more coatings may be applied to the calcium hypochlorite particles. Each coating may be comprised of one or more coating materials. Varying the coating loading will lead to varied delayed release of the calcium hypochlorite into the wash liquor. Additionally, the solubility of the coating material used to coat the calcium hypochlorite will also factor into the amount of time it takes for the calcium hypochlorite to begin/complete release into the wash liquor. For example, materials that are less soluble such as silicates will release slower than coatings comprised of sulfate. After the calcium hypochlorite particles are coated, the coated particles are then blended with the rest of the formula ingredients and the resulting material is tableted at different pressures depending on the desired hardness of the tablet. The combined blended ingredients are pressed into a tablet at low to moderate pressure (i.e.; from about 1 ton (0.9 metric tons) to about 20 tons (18 metric tons)). In one non-limiting example, various coatings of salts such as shown in Table II below are deposited onto calcium hypochlorite particles wherein the calcium hypochlorite particles have an average particle size diameter ranging from approximately 500 microns to about 1200 microns in size. The coatings may be applied to the particles using coating equipment such as a Model 400 Portable Fluid Bed Wurster Coater with a 4 inch (10 cm)/6 inch (15 cm) Bull utilizing a typical Wurster Process such as that available from the Coating Place Incorporated of Verona Wis. More than one layer of coating can be applied if desired. Each coating layer if desired, can be comprised of more than one coating material. When a second layer of coating is added it is added to the first layer after the first layer has been fully applied. After the hypochlorite is coated, all the ingredients for the tablet are premixed into a blended powder. The blended powder is pressed into a tablet using a common tablet shape such as the plain flat face shape described above. The mold diameter 1.5 inches (3.8 cm). The amount of pressure used to make the tablet is approximately 10 tons (9 metric tons). One suitable lab press for this purpose is the Carver Laboratory press available from Carver Incorporated of Wabash, Ind.

TABLE II
Example Compositions for Tablet Comprising Coated Calcium Hypochlorite Particles

| | | | | |
|---|---|---|---|---|
| | | Wt. % | | |
| Tablet | Grams | Per tablet | Supplier | Location |

EXAMPLE #5

| | | | | |
|---|---|---|---|---|
| Calcium Hypochlorite | 10.0 | 20.4 | PPG | Pittsburgh, PA |
| (coated*) | | | | |
| LAPONITE RD | 5.0 | 10.2 | Southern Clay Products | Princeton, NJ |
| CELITE | 1.0 | 2.0 | Celite Corp. | Lompoc, CA. |
| Sodium Citrate dihydrate | 9.0 | 18.4 | Tate & Lyle | Decatur, Il |
| Sodium Borate | 8.0 | 16.3 | North American Chem. | Shawnee Mission, KS |
| Sodium Sulfate | 16.0 | 32.7 | EMD Chemicals | Gibbstown, NJ |

*Coated = Where the coating comprises a single layer of sodium silicate using a dispersion that yields a
20% wt/wt concentration of the sodium silicate to calcium hypochlorite.

EXAMPLE #6

| | | | | |
|---|---|---|---|---|
| Calcium Hypochlorite | 10.0 | 25.0 | PPG | Pittsburgh, PA |
| (coated*) | | | | |
| LAPONITE RD | 5.0 | 12.5 | Southern Clay Products | Princeton, NJ |
| Sodium Citrate dihydrate | 9.0 | 22.5 | Tate & Lyle | Decatur, Il |
| Surfactant blend (Mid-Chain | 4.0 | 10.0 | P&G | Cincinnati, OH |
| Branched Alkyl Sulfate and | | | | |
| Alkyl Sulfate) | | | | |
| Sodium Sulfate | 11.35 | 28.3 | EMD Chemicals | Gibbstown, NJ |
| BRIGHTENER 49 | 0.15 | 0.4 | Ciba | Basel Switzerland |
| DTPA Agglomerate | 0.5 | 1.3 | P&G | Cincinnati, OH |

*Coated = Where the first coating applied comprises of 10% wt/wt magnesium sulfate and
then a second coating comprises of 15% wt/wt sodium silicate (both ratioed to calcium hypochlorite)

EXAMPLE #7

| | | | | |
|---|---|---|---|---|
| Calcium Hypochlorite | 10.0 | 25.0 | PPG | Pittsburgh, PA |
| (coated*) | | | | |
| LAPONITE RD | 5.0 | 12.5 | Southern Clay Products | Princeton, NJ |
| Sodium Citrate dihydrate | 12.0 | 30.0 | Tate & Lyle | Decatur, Il |
| Surfactant blend (Mid-Chain | 6.0 | 15.0 | P&G | Cincinnati, OH |
| Branched Alkyl Sulfate and | | | | |
| Alkyl Sulfate) | | | | |
| Sodium Sulfate | 4.32 | 10.8 | EMD Chemicals | Gibbstown, NJ |
| BRIGHTENER 49 | 0.15 | 0.4 | Ciba | Basel Switzerland |
| Sodium polyacrylate | 2.0 | 5.0 | Rohm & Haas | Springhouse, PA |
| Ammonium Fluoride | 0.5 | 1.3 | General Chemical Corp | Parsippany, NJ |

*Coated = Where the first coating applied comprises of 10% wt/wt sodium carbonate and then a second
coating comprises of 20% wt/wt sodium silicate (both ratioed to calcium hypochlorite).

EXAMPLE #8

| | | | | |
|---|---|---|---|---|
| Calcium Hypochlorite | 11 | 37.9 | PPG | Pittsburgh, PA |
| (coated*) | | | | |
| LAPONITE RD | 2.0 | 6.9 | Southern Clay Products | Princeton, NJ |
| Sodium Citrate dihydrate | 11.0 | 37.9 | Tate & Lyle | Decatur, Il |
| Sodium Chloride | 5 | 17.2 | EMD Chemicals | Gibbstown, NJ |

Coated* = Where the first coating applied comprises of 12% wt/wt sodium sulfate and then a second
coating comprises of 18% wt/wt sodium silicate (both ratioed to calcium hypochlorite).

### 3. Homogenously Blended Tablet

In this embodiment the solid form comprises a tablet which includes calcium hypochlorite and other materials which are homogenously blended and pressed. Examples of homogenously blended tablets are shown in Examples 9-12 shown below. Examples 9-12 are uncoated tablets. By creating a tablet which is pressed hard, the dissolution rate of the tablet can be reduced versus a tablet that is not pressed as hard. If desired, a chlorine scavenger can optionally be included with the tablet or alternatively added separately to the wash liquor should it be desired to scavenge any small amounts of chlorine that might be released at the beginning of the wash.

TABLE III
Example Compositions for a Homogenously Blended Tablet

| | | | | |
|---|---|---|---|---|
| | | Wt. % | | |
| Tablet | Grams | Per tablet | Supplier | Location |

EXAMPLE #9

| | | | | |
|---|---|---|---|---|
| Calcium Hypochlorite | 10.0 | 20.4 | PPG | Pittsburgh, PA |
| LAPONITE RD | 5.0 | 10.2 | Southern Clay Products | Princeton, NJ |
| CELITE | 1.0 | 2.0 | Celite Corp. | Lompoc, CA. |
| Sodium Citrate dihydrate | 9.0 | 18.4 | Tate & Lyle | Decatur, Il |
| Sodium Borate | 8.0 | 16.3 | North American Chem. | Shawnee Mission, KS |
| Sodium Sulfate | 16.0 | 32.7 | EMD Chemicals | Gibbstown, NJ |

EXAMPLE #10

| | | | | |
|---|---|---|---|---|
| Calcium Hypochlorite | 10.0 | 25.0 | PPG | Pittsburgh, PA |
| LAPONITE RD | 5.0 | 12.5 | Southern Clay Products | Princeton, NJ |
| Sodium Citrate dihydrate | 9.0 | 22.5 | Tate & Lyle | Decatur, Il |
| Surfactant blend (Mid-Chain | 4.0 | 10.0 | P&G | Cincinnati, OH |
| Branched Alkyl Sulfate and | | | | |
| Alkyl Sulfate) | | | | |
| Sodium Sulfate | 11.35 | 28.3 | EMD Chemicals | Gibbstown, NJ |
| BRIGHTENER 49 | 0.15 | 0.4 | Ciba | Basel Switzerland |
| DTPA Agglomerate | 0.5 | 1.3 | P&G | Cincinnati, OH |

EXAMPLE #11

| | | | | |
|---|---|---|---|---|
| Calcium Hypochlorite | 10.0 | 25.0 | PPG | Pittsburgh, PA |
| LAPONITE RD | 5.0 | 12.5 | Southern Clay Products | Princeton, NJ |
| Sodium Citrate dihydrate | 12.0 | 30.0 | Tate & Lyle | Decatur, Il |
| Surfactant blend (Mid-Chain | 6.0 | 15.0 | P&G | Cincinnati, OH |
| Branched Alkyl Sulfate and | | | | |
| Alkyl Sulfate) | | | | |
| Sodium Sulfate | 4.32 | 10.8 | EMD Chemicals | Gibbstown, NJ |
| BRIGHTENER 49 | 0.15 | 0.4 | Ciba | Basel Switzerland |
| Sodium polyacrylate | 2.0 | 5.0 | Rohm & Haas | Springhouse, PA |
| Ammonium Fluoride | 0.5 | 1.3 | General Chemical Corp | Parsippany, NJ |

EXAMPLE #12

| | | | | |
|---|---|---|---|---|
| Calcium Hypochlorite | 11 | 37.9 | PPG | Pittsburgh, PA |
| LAPONITE RD | 2.0 | 6.9 | Southern Clay Products | Princeton, NJ |
| Sodium Citrate dihydrate | 11.0 | 37.9 | Tate & Lyle | Decatur, Il |
| Sodium Chloride | 5 | 17.2 | EMD Chemicals | Gibbstown, NJ |

EXAMPLE #13

| | | | | |
|---|---|---|---|---|
| Calcium Hypochlorite | 11 | 44 | PPG | Pittsburgh, PA |
| LAPONITE RD | 2.0 | 8.0 | Southern Clay Products | Princeton, NJ |
| Sodium Citrate dihydrate | 3.0 | 12 | Tate & Lyle | Decatur, Il |
| Sodium Chloride | 9 | 36 | EMD Chemicals | Gibbstown, NJ |

EXAMPLE #14

| | | | | |
|---|---|---|---|---|
| Calcium Hypochlorite | 11 | 58 | PPG | Pittsburgh, PA |
| LAPONITE RD | 2.0 | 11 | Southern Clay Products | Princeton, NJ |
| Sodium Citrate dihydrate | 3.0 | 16 | Tate & Lyle | Decatur, Il |
| Sodium Chloride | 3.0 | 16 | EMD Chemicals | Gibbstown, NJ |

### METHOD OF USING THE SOLID FORM OF THE PRESENT INVENTION

The solid form of the present invention may be added to the wash liquor of a laundry washing process such as a washing machine prior to the addition of the laundry detergent or preferably after the addition of the laundry detergent. Typically, upon addition of the solid form to the wash liquor, the calcium hypochlorite is released from the solid form over a period of from about 1 minute to about 10 minutes. Typically, complete dissolution of the solid form occurs from about 1 minute to about 12 minutes after the solid form is added to the wash liquor.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention. All documents cited herein are in relevant part, incorporated by reference. The citation of any document is not to be construed as an admission that it is prior art with respect to the present invention.

What is claimed is:

1. A solid bleach containing form for use in a laundry washing process, said solid bleach containing form comprising: a tablet wherein said tablet is comprised of calcium hypochlorite and one or more calcium sequestering agents.

2. The solid bleach containing form of claim 1 wherein said calcium sequestering agent comprises a citrate salt or citric acid.

3. The solid bleach containing form of claim 2 wherein said citrate salt is sodium citrate dihydrate.

4. The solid bleach containing form of claim 1 wherein said solid bleach containing form further comprises a disintegrating agent.

5. The solid bleach containing form of claim 4 wherein said disintegrating agent is carboxymethyl cellulose, bentonite clay, synthetic layered silicate/clay, or a combination thereof.

6. The solid bleach containing form of claim 2 wherein said calcium hypochlorite is comprised of particles wherein said particles include a coating.

7. The solid bleach containing form of claim 6 wherein said coating is sodium sulfate, sodium chloride, sodium carbonate, sodium silicate, magnesium sulfate, or a combination thereof.

8. The solid bleach containing form of claim 6 wherein said solid bleach containing form further comprises a disintegrating agent.

9. The solid bleach containing form of claim 1 wherein said solid bleach containing form comprises an inner core and an outer core wherein said calcium hypochlorite is included in said inner core and said calcium sequestering agent is included in said outer core.

10. The solid bleach containing form of claim 9 wherein said calcium sequestering agent comprises a citrate salt or citric acid.

11. The solid bleach containing form of claim 6 wherein said solid bleach containing form further comprises a surfactant.

12. The solid bleach containing form of claim 11 wherein said surfactant is linear alkene benzene sulfonate, alkyl sulfate, or a combination thereof.

13. The solid bleach containing form of claim 1 wherein said solid bleach containing form further includes brightener, enzyme, or a combination thereof.

14. A process for bleaching fabric, said process comprising:
a) providing a solid bleach containing form wherein said solid bleach containing form comprises calcium hypochlorite and a calcium sequestering agent; and
b) adding said solid bleach containing form to a laundry wash liquor.

15. The process of claim 14 wherein said process further comprises dissolving said solid bleach containing form in said laundry wash liquor.

16. The process of claim 14 wherein said process further comprises a disintegrating agent.

17. The process of claim 15 wherein complete dissolution of said solid bleach containing form occurs in from about 1 minute to about 12 minutes after said solid bleach containing form is added to said laundry wash liquor.

18. The process of claim 15 wherein upon addition of said solid bleach containing form to said wash liquor, said calcium hypochlorite is released from said solid bleach form over a time period of from about 1 minute to about 10 minute.

19. The process of claim 14 wherein said calcium sequestering agent comprises a citrate salt or citric acid.

20. The process of claim 19 wherein said citrate salt is sodium citrate dihydrate.

21. The process of claim 14 wherein said calcium hypochlorite comprises particles which include a coating.

22. The process of claim 15 wherein said solid bleach containing form comprises an inner core and an outer core wherein said calcium hypochlorite is included in said inner core and said calcium sequestering agent is included in said outer core.

23. The process according to claim 22 wherein said solid bleach containing form further comprises a surfactant.

24. The process according to claim 23 wherein said surfactant is linear alkene benzene sulfonate, alkyl sulfate, or a combination thereof.

25. The process according to claim 23 wherein said surfactant is contained in said outer core of said solid bleach containing form.
